(19) United States
(12) Patent Application Publication
(10) Pub. No.: US 2005/0242595 A1
(43) Pub. Date: Nov. 3, 2005

(54) Seal device with a ring and a spring clip in one stop for the vehicle license plate

(76) Inventor: Jong Ho Yun, Sasang-Ku (KR)

Correspondence Address: Eugene Oak, Ph.D.;J.D., Patent Attorney, 610 S. Van Ness Ave., Los Angeles, CA, 90005, US

(21) Appl. No.: 11/102,265

(22) Filed: Apr. 8, 2005

(30) Foreign Application Priority Data
Apr. 10, 2004 (KR) 10-2004-0025998

(51) Int. Cl. E05B 39/02

(52) U.S. Cl. 292/327

(57) ABSTRACT

For this invention, it is not only a ring with no normal sealing bolt or nut to open a side of cap but also a round plane cover as a ring with a wide steel in a middle part at both edges to do not weld and to open and to set on the trisections to post under a part and a body as a tongue to stand and to support in an inside of nut for a prop to joint in a time a finger to press as we say a method of one touch with a sealed bolt, round wide steel in middle to open as a ring and nut so call a cover. It is a new type to process ever to try until today to use all bolts and nuts to set a rounded wide steel rounded clip with three wings and in a middle part across both ends of steel plane without any weld to join for a round, and it is not to release until a bolt or nut to break down.

### FIELD OF THE INVENTION

Current application is related with an antitheft seal for a license plate of a car.

### BACKGROUND OF THE INVENTION

Many of vehicle owner have experience losing their license plate from their vehicle bumpers by someone who has needed it's to attach for his stolen car, and he drove that car which has attached it for a bad purpose. This invented sealed bolt cover with a ring or a clip has not to replace any license plate, because of these invented license plates to break into a half blank from a ring or a clip in a bolt cover and a cap or a nut to fix together for a good engagement and to do not release. Therefore, it is the main purpose that no one could not stolen any license plate from this vehicles which has attached this license plate, if it is a case of this invented seal bolt with a ring and a clip or both devices to use. Prior arts disclose sealed bolts as a sunken head and to put a sealed cap between a nut and a bolt. Current application utilizes ring between a bolt cover's groove and a nut's groove for a ring to joint and another with a spring clip to insert into a cap as a tongue at this clip-end on the trisections to hold each bolt cover with a cap until those sealed devices or this license plate to break down. A clip in this invention to make a thin steel plate to roll as a circle but these both edges have not welded for a crevice to be enlarged for a passing way through a bolt head and to set on a clip location place of bolt and three clip-ends as tongues on those trisections at those screw places and then those are never released for any power to give.

### SUMMARY OF THE INVENTION

The technical subject to build for this invention is not only a ring with no normal sealing bolt and nut to open a side of cap but also a round plane cover as a ring with a wide steel in a middle part at both edges to do no weld and to open and to set on the three parts in six section on one by one to post under a part and a body as a tongue to stand and to support in a nut for a prop to joint in a time a finger to press as we say a method of one stop which has a sealed bolt, a side closed cap with a round wide steel ring. It is a new type to process ever to try until today to use all bolts and nuts to set a rounded steel clip with three clip-ends as three wings and in a middle part across both ends of steel plane with no weld to join for a round, and it is not to release until a bolt or nut to break down. Current application utilizes ring between a bolt cover's groove and a nut's groove for a ring to joint and another with a spring clip to insert into a cap as a tongue at this clip-end on the trisections to hold each bolt cover with a cap until those sealed devices or this license plate to break down. A clip in this invention to make a thin steel plate to roll as a circle but these both edges have not welded for a crevice to be enlarged for a passing way through a bolt head and to set on a clip location place of bolt and three clip-ends as tongues on those trisections at those screw places and then those are never released for any power to give.

### BRIEF DESCRIPTION OF THE DRAWINGS

FIG. 1 is a squint view of this invented one touch seal device,

FIG. 1-1 is a squint view of three parts spring clips in a seal bolt cover.

FIG. 1-2 is a squint view of a ring to insert in both grooves between a bolt cover and a nut.

FIG. 2 is a section view of a seal bolt, a nut and a ring.

FIG. 2-1 is a section view of AA′ for a seal bolt, of BB′ for a nut and CC′ for a ring.

FIG. 2-2 is a squint view of a seal bolt cover, a spring cap and a clip.

FIG. 3 is an upper plane view of some accessories for a seal device.

FIG. 4 is an upper plane view of a vehicle license plane.

FIG. 4-1 is an upper plane view of a bar code and a half blank to press around an inside line on a vehicle license plate.

FIG. 4-2 is a section view of a half blank on a license plate.

FIG. 5 is a section view of a sealed figure with a license plate at a bumper.

FIG. 5-1 is a section view of a sealed figure with a sealed bolt cover, a cap and a clip.

FIG. 5-2 is a section view of a sealed bolt, a nut and a ring to seal.

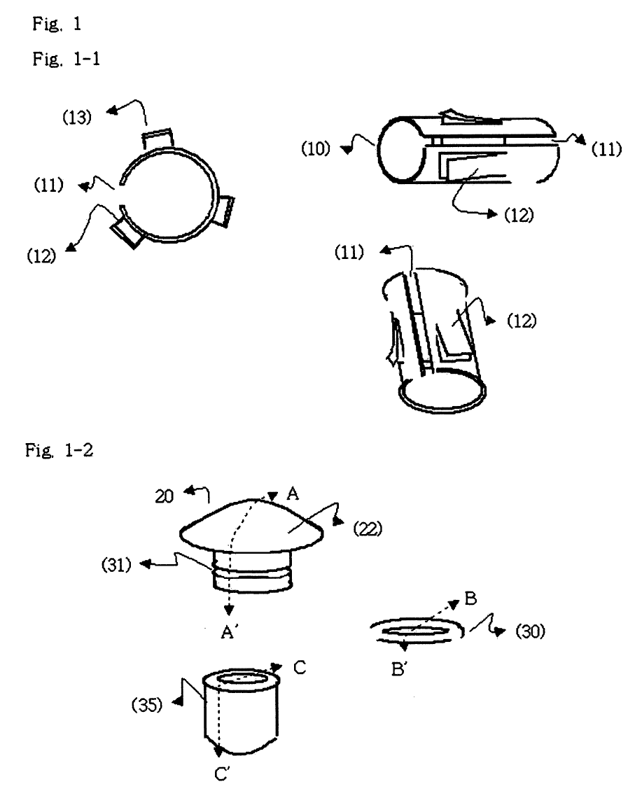

A spring clip (10) to use on a seal bolt cover (25) has normally made it with a steel plate of 0.9 mm and a length of 24 mm to divide on a trisections to set these 3 wings at each section in size of 3 mm under its bottom and a clip-end (13) as tongue type (13), as like a wing is 5 mm in a length. And a cap (15) at this end of wing is pushed into a clip location place (21) into a cap (15) and to put in a seal bolt cover (25) for a function which has never released with any damage.

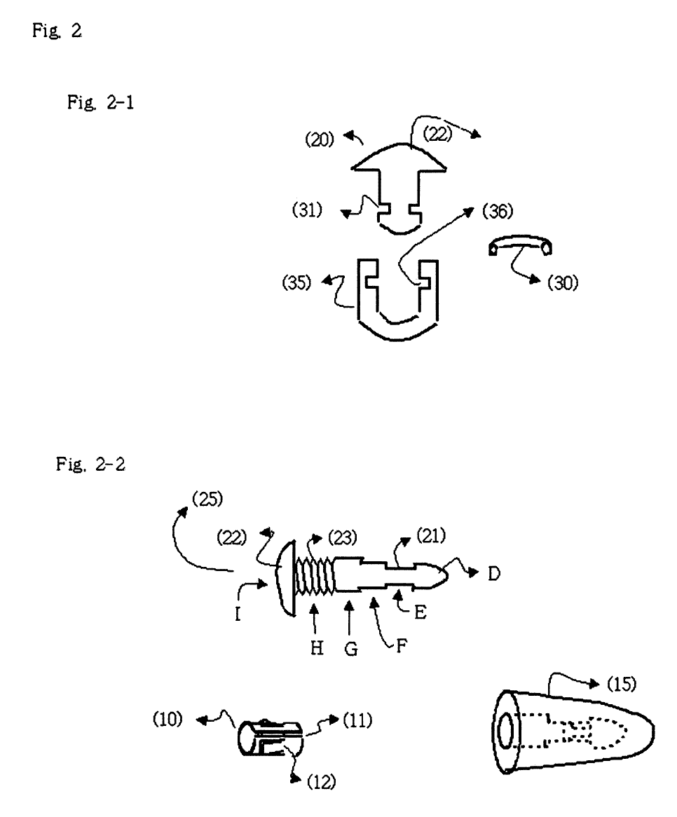

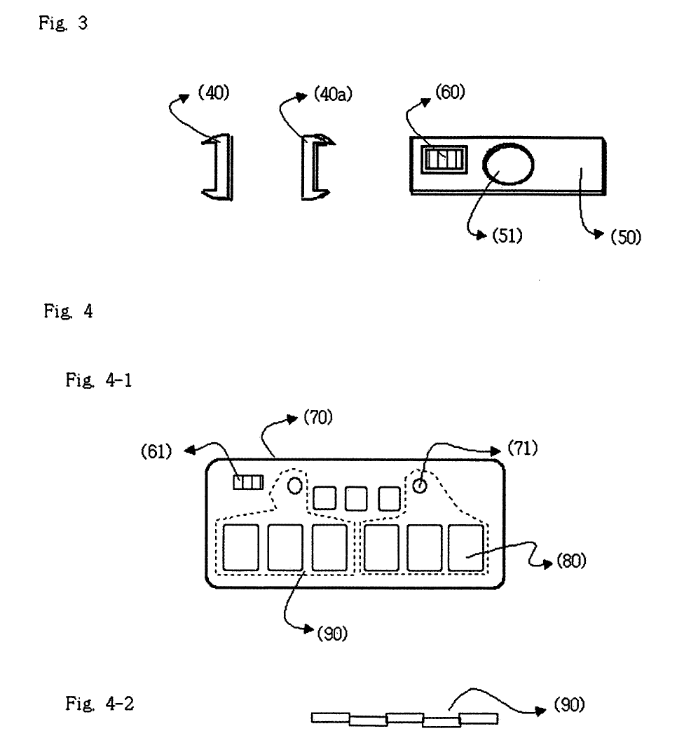

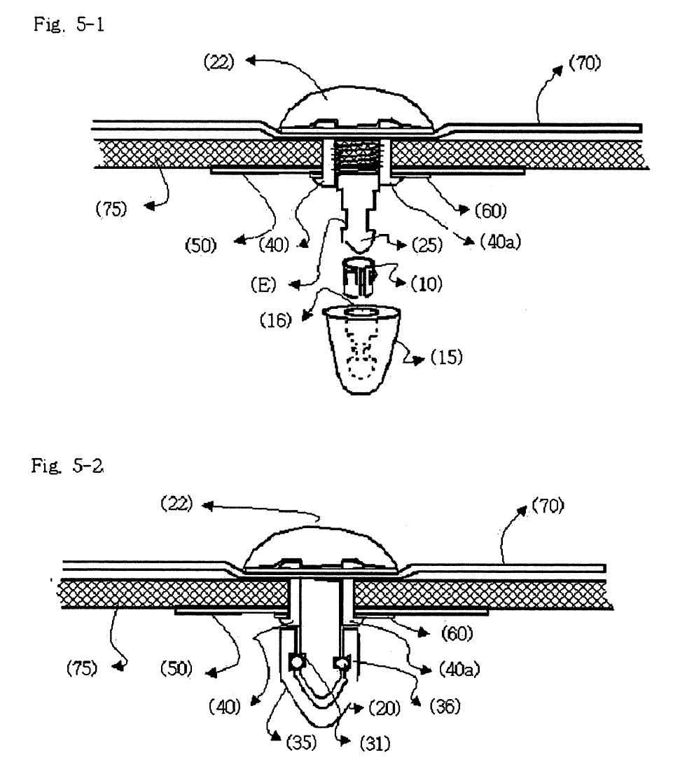

Also a license plate (70) has been hanged at a bumper (75) to put a sealed bolt cover (20) into a plate hole (71) to turn through a screw part (23) and to hang a bar code (42) together, and a cap (15) with a spring clip (10) to insert at a bolt cover (25) before a cap (15) to close, then a clip (10) will be passed through a bolt cover (D) in FIG. 2-2, and a clip (10) on a clip location part (E) to sit, and then a clip end (13) has to set toward a sealed stamp die (22) and to press with a thumb for its combination, so call an one touch seal device.

In such case, a bar code (61) to print on a license plate (70) near a plate hole (71) on a vehicle license plate (70) has posited already the same numbers, also to press a cod as the same license numbers (80) on this license plate (70).

For a holding method to attach license plate (70) to a bumper (75), it needs two bolt covers (25) in every bolt holes (71) to use though these holes (71) with a license plate (70), bolt covers (20), caps (30) and clips (10) to press for a method of one stop as one touch to sound a light noise of click”.

Another invented seal bolt (20) has made a type of half moon on its top with a metal and to adjust with a license plate (70) for its coordination and to hang a washer under a seal bolt (20) on a license plate (70) for its smooth turn, also to hang both sides with two rivets (40, 40a) at a left and at a right side also as it in both holes on its bumper across the holes.

At its backside of bumper, a bar code band (60) is set into both holes of rivets (40, 40a) and to put a washer before a metal ring (30) as a rounded type (31) in a rounding groove (31) in the middle part of seal bolt (20) an a nut (35) to push until its bottom to touch at a bottom of bolt (20), then a metal ring (30) to set in an alliance with both rounding groove (31, 36).

By the way of once more explanation on these orders as the follows: at the first, it gets this license plate (70), and then at the second, it does to adjust at a hole (71, 71a) of bumper (75), and at the third, it does to insert with two washers in a straight to both holes (71, 71a) and to adjust at a rear side of bumper (70), and for the fourth, it does to set a bar code (60), and to be passed for seal bolt (20) through its hole (71, 71a), and for the fifth, it does to set another washers and for the sixth, it does to set both rivets (40, 40a) in every hole (71, 71a), and for the seventh, it does to push with a seal bolt (20) from a side of license plate (70) and to fit a ring (30) into a bolt's groove (31) and then to close with a nut (35) tightly, then this license plate (70) does not loosed in any power for its release more and it would be a tamped seal bolt (20) as like a no tamper seal bolt (20) with a ring (30) and a nut (35).

In this function as a seal bolt (20) to insert a metal ring (30) on a seal bolt's groove (31) to connect in a nut's groove (36) also with a half blank (90), there is never released in any action to tamper with no intact license plate.

1. A seal device for a vehicle license plate in one stop with a spring clip, a seal bolt cover and a cap;
(a) A seal bolt cover (20) has made a rounded bolt in 6 positions, first a sealed stamp die (22) in a diameter of 23.8 millimeters as a half moon type, and a screw place (22) in a diameter of 18 millimeters, third a G position of non screw in a diameter of 19.4 millimeters, forth a clip place (21) as a clip location part (E) in diameter of 6.8 millimeters, fifth a clip-end (F), sixth a last on a bolt head (D) in a diameter of 8 millimeters.
(b) A spring clip (10) has normally made it with a thin plate steel to dig trisections in a size of adjusting distance to keep at three bottoms as a tongue or a wing type.
(c) A cap (30) has made a closed side and rounded nut for a spring clip (10) to insert,
(d) On a license plate (70) near a plate hole (71) for a seal bolt, a bar code (60, 61) has printed its license words or numbers as same as its own vehicle license plate (70).

2. A seal device for a vehicle license plate in one stop with a seal bolt covers, a ring and a nut;
(a) a stamped seal bolt (20) as a type of half moon on its top with a metal and to adjust with a license plate (70) for its coordination, a nut (35) of which type of closed bottom in a middle to round a groove (36) for a ring (30) to sit in it, and a ring (30) as a rounding type to sit between a groove (31) of stamped seal bolt (20) and a nut′ groove (36).
(b) two Rivets (40, 40a) at a left and a right side also as it in both holes on its bumper across the holes, and a washer in a pair between a bolt (20) and a license plate (70) for its smooth turn, also in both holes of bumper at a forward and a rearward,
(c) a Bar code (61) to print on a license plate (70) and a bar code (60) to set in another plate before a nut to close,

3. A seal device for a tamper to close in one stop with a half blank in a circle line on a vehicle license plate:
(a) a seal bolt cover (25), a spring clip (10) and a cap (15) to combine with each other for a tamper to close in a hole (71),
(b) a sealed bolt (20), a nut (35) and a ring (30) for a tamper to close in another seal device for a hole (71a).
(c) a drawing circle half blank (90) line with some numbers and holes (71, 71a) in a half blank (90) to press for tamper to close on a license plate (70).
